(19) United States
(12) Patent Application Publication
(10) Pub. No.: US 2026/0318365 A1
(43) Pub. Date: Oct. 15, 2026

(54) SUSPENDED BEARING COUPLING

(71) Applicant: PEK AUTOMOTIVE D.O.O., LOGATEC (SI)

(72) Inventor: Mikhail Kostkin, Vrhnika (SI)

(73) Assignee: PEK AUTOMOTIVE D.O.O., LOGATEC (SI)

(21) Appl. No.: 19/481,183

(22) PCT Filed: May 9, 2023
(86) PCT No.: PCT/IB2023/000191

§ 371 Date: Nov. 4, 2025

(51) Int. Cl. F16D 3/38; F16C 33/10

(52) U.S. Cl. CPC F16D 3/385; F16C 33/1045; F16C 2310/00

(57) ABSTRACT

The invention relates to agricultural equipment. The suspended bearing coupling includes a hub with a bore for housing an internal connecting shaft. A coupling suspension is attached to the mid-section of the hub outer surface. The external surfaces of both sides of the hub are designed to accommodate antifriction bearings, and a flange is installed on the outer surface of each antifriction bearing. A slide bearing is installed between the inner surface of each flange and said inner connecting shaft. Coaxial bores are made in each flange and in the inner connecting shaft to enable a spaced accommodation of the pins connecting the flange with the inner connecting shaft. The pins are designed to prevent their falling out. The inner connecting shaft in the bore of the hub is spaced by a gap, and the outer surfaces of each flange enable their fastening to outer shafts.

### FIELD OF INVENTION

The invention relates to agricultural equipment, more specifically to suspended couplings used for coupling shafts.

### PRIOR ART

Suspended couplings are used in case when two or more shafts need to be coupled together and supported against an outer body. In particular, the present invention can be applied to agricultural choppers having their working tools mounted on a rotating horizontal shaft consisting of separate sections connected with suspended couplings. In this embodiment the chopping tools are represented by radial cutting-edge hammers installed on shaft sections.

In such applications, the couplings that connect shaft sections experience sufficiently heavy dynamic loads, thus compensating for angular displacements between the shaft sections.

Various designs of suspended couplings for connecting shaft sections are known.

For instance, utility model patent CN204250814, publication date 2015 Apr. 8, ICL B65G33/32, discloses the design of a multisectional connecting device for a screw conveyor. The connecting device includes a coupling shaft passing through an adjustable central bearing, with both ends of said coupling shaft being connected to spindle connecting lugs.

Also, patent for invention U.S. Pat. No. 3,633,981, publication date 1972 Jan. 11, ICL F16D1/02, describes the design of a coupling for connecting adjacent shaft ends; said design includes a one-piece coupling body with a longitudinal extending bore adapted to receive the adjacent ends of the shaft, and roller pins fixed on the coupling body transversely to the longitudinal bore and limiting the inward longitudinal movement of the shaft ends.

The pins are removable to allow a longitudinal travel of each shaft into the bore. An antifriction bearing is disposed about the coupling body and adapted to be secured to a support hanger for supporting the adjacent ends of the shafts in coupled relation.

Also known is patent for invention U.S. Pat. No. 8,523,688, publication date 2013 Sep. 3, ICL B65G33/32, which discloses the design of a suspended bearing coupling. The coupling includes a shaft supporting bearing, which is installed between at least two hub units mounted on both sides of the bearing on the shaft. The assembly also includes a suspension mount having a bearing-receiving bore for providing a functional connection of said bearing with the suspension mount. Each hub unit includes a flexible inner hub attached to the shaft and a flexible outer hub resiliently attached to the flexible inner hub. Therein, the flexible outer hubs can be connected to tubular shafts.

This invention is the closest analog to the case in point.

### DISCLOSURE OF INVENTION

The technical result achieved in the present invention is an enhanced reliability of the suspended bearing coupling under increased static and dynamic load.

The suspended bearing coupling includes a hub with a bore that accommodates an inner connecting shaft, while the mid-section of the outer surface of said hub provides for a possibility of rigid attachment of the coupling suspension thereto. The outer surfaces of the mid-section of both sides of the hub provide for accommodation of inner surfaces of antifriction bearings, with each antifriction bearing having a flange installed on its outer surface. A slide bearing is installed between the inner surface of each flange and said inner connecting shaft. Coaxial bores are made in each flange and in the inner connecting shaft to enable a spaced accommodation of the pins connecting the flange with the inner connecting shaft. The design of the pins prevents their falling out of the bores, while the inner connecting shaft is installed with a gap in the hub bore, and the outer surfaces of each flange enable their attachment to the outer shafts going to the coupling.

In the present instance, the antifriction bearings of choice shall comprise double-row radial bearings.

Similarly, the slide bearings of choice shall comprise radial-spherical slide bearings. Furthermore, the pin is secured from falling out of the bore by means of bolts mounted on pin protrusions.

Besides, the flange contains an oil duct for lubricating the coupling bearings.

Also, the suspension is fastened to the hub by welding.

### BRIEF DESCRIPTION OF DRAWINGS

FIG. 1 gives a section view of the suspended bearing coupling assembly.

FIG. 2 gives a general view of the suspended bearing coupling assembly.

FIG. 3 shows an example of the coupling application for connecting the shafts of an agricultural chopper equipped with cutting and crushing working tools.

### EMBODIMENTS OF THE INVENTION

The suspended bearing coupling 1 in the given embodiment is represented by a coupling, which connects several sections of an agricultural chopper shaft.

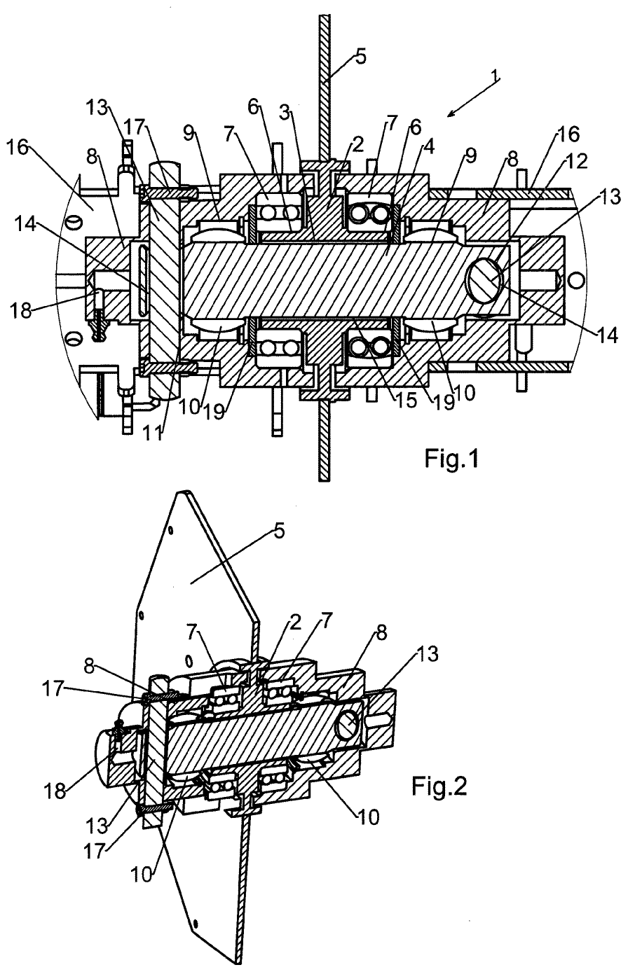

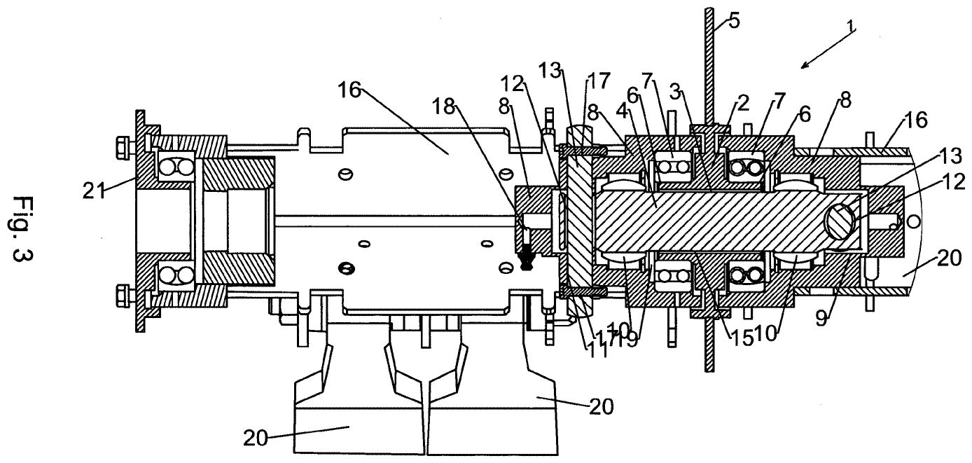

The suspended bearing coupling 1 (FIG. 1-FIG. 3) includes a hub 2 with a bore 3 accommodating an inner connecting shaft 4. The hub 2 in the mid-section of its outer surface is rigidly fixed, for example by welding, to a suspension 5, which fastens the entire coupling 1 to the outer body (not shown in the Figures). Both sides of the hub 2 carry outer surfaces 6 used for accommodating the inner surfaces of slide bearings 7. A flange 8 is installed on the outer surface of each slide bearing 7. In case of heavy structural loads, the slide bearings 7 shall comprise double-row radial bearings.

A slide bearing 10 is installed between the inner surface 9 of each flange 8 and said inner connecting shaft 4. The slide bearings 10 shall comprise radial-spherical slide bearings.

Each flange 8 and the inner connecting shaft 4 have coaxial bores 11 and 12 for accommodating pin 13, which is spaced from the shaft 4 by a gap 14. Pins 13 connect the flanges 8 with the inner connecting shaft 4. The pins 13 are secured from falling out of bores 11 and 12 with bolts 17.

The inner connecting shaft 4 in bore 3 of hub 2 is spaced by a gap 15. The outer surfaces of each flange 8 enable fixing of outer shafts 16 thereto, said shafts being attached to coupling 1.

The suspended bearing coupling is equipped with a lubrication system. The oil duct 18 used for supplying the lubricant primarily for sliding bearings 10 is shown in the Figures.

The suspended bearing coupling operates as follows. The outer shaft, specifically a section of the outer shaft 16, transmits rotation to the flange 8. The flange 8 transmits the rotation further to the inner connecting shaft 4 being connected to said shaft by means of the pin 13. Since the connection between the inner connecting shaft 4 and the pin 13 features the gap 14, the misalignment of the outer section of the shaft 16 and the inner connecting shaft 4 is compensated by said gap 14 and slide bearings 10. Furthermore, the rotation is transmitted by means of another pin 13 to the opposite flange, which rotates still another section 16 of the outer shaft. The power loads act basically upon the slide bearings 7.

In general, the assembly of the suspended bearing coupling 1 can withstand significant static and dynamic loads acting on individual shaft sections, and simultaneously compensate for axial misalignment of individual sections.

FIG. 3 shows an example of how shafts can be connected by means of the suspended bearing coupling of an agricultural chopper equipped with cutting and crushing working tools. The first section of the shaft 16 is connected to the drive (not shown in the Figures) by means of a section flange 21. The section body of the shaft 16, which, in this example, is made of flat rectangular sheets, is equipped with radial hammers 20 intended for chopping biomass. During the chopping operation, said hammers generate significant dynamic loads and vibrations in the shaft section 16, which are effectively compensated by the design of the suspended bearing coupling 1.

### INDUSTRIAL APPLICABILITY

The claimed design can be used for connecting the shafts of various agricultural equipment and other types of machinery.

1. A suspended bearing coupling including a hub with a bore accommodating an inner connecting shaft, wherein the hub in the mid-section of the outer surface enables a rigid attachment of coupling suspension thereto; concurrently, external surfaces accommodating internal surfaces of slide bearings are made on both sides of the hub mid-section and a flange is fixed on the outer surface of each sliding bearing; wherein a slide bearing is installed between the inner surface of each flange and said inner connecting shaft; wherein, coaxial bores are made in each flange and in the inner connecting shaft to provide a spaced accommodation of the pins, which connect the flange and the inner connecting shaft, said pins being secured from falling out of the bores; with said inner connecting shaft installed in the bore of the hub with a gap, while the outer surfaces of each flange enable their attachment to the outer shafts connected to the coupling.

2. A suspended bearing coupling as per claim 1, wherein the antifriction bearings comprise double-row radial bearings.

3. A suspended bearing coupling as per claim 1, wherein the slide bearings comprise radial-spherical slide bearings.

4. A suspended bearing coupling as per claim 1, wherein the pin is secured against falling out of the bores by means of bolts fixed on pin protrusions.

5. A suspended bearing coupling as per claim 1, wherein the flange contains an oil duct for lubricating the coupling bearings.

6. A suspended bearing coupling as per claim 1, wherein the suspension is fixed to the hub by welding.
